(19) United States
(12) Patent Application Publication
(10) Pub. No.: US 2012/0198810 A1
(43) Pub. Date: Aug. 9, 2012

(54) STRUT AIRFOIL DESIGN FOR LOW SOLIDITY EXHAUST GAS DIFFUSER

(75) Inventors: Asif Iqbal Ansari, Bangalore (IN); Deepesh D. Nanda, Bangalore (IN)

(73) Assignee: General Electric Company, a New York Corporation, Schenectady, NY (US)

(21) Appl. No.: 13/021,136

(22) Filed: Feb. 4, 2011

(51) Int. Cl. F02C 7/00

(52) U.S. Cl. 60/39.5

(57) ABSTRACT

This disclosure relates to a strut airfoil for use in an exhaust diffuser. The strut airfoil described herein generally is asymmetric. The strut airfoil has a curved leading edge, a curved tail edge, and two surfaces connecting the leading edge and tail edge. This disclosure also relates to gas turbines that contain an exhaust diffuser with struts that are covered with a strut airfoil.

### FIELD OF THE INVENTION

The subject matter described herein relates to gas turbines, and, more specifically, to strut airfoils in a diffuser of a gas turbine.

### BACKGROUND OF THE INVENTION

A gas turbine engine includes a compressor having a number of compressor blades disposed on a shaft, with the compressor blades and shaft configured to define a decreasing volume. Airflow ingested into the gas turbine is compressed as it passes through the compressor. A number of combustors are disposed downstream of the compressor, where air and fuel are mixed and the fuel is ignited. A multi-stage turbine is disposed downstream of the combustors.

First stages of the multi-stage turbine are defined by a number of turbine vanes disposed on the shaft of the compressor. Final stages of the multi-stage turbine are defined by a number of turbine vanes disposed on an output drive shaft, which rotates independently of the shaft of the compressor. The heated compressed air flow from the combustors turns the multi-stage turbine. The rotation of the first stages of the multi-stage turbine rotates the shaft of the compressor. The rotation of the final stages of the multi-stage turbine rotates the output drive shaft, which in turn drives a generator.

A diffuser is disposed aft of the final stages of the multi-stage turbine and is configured to decelerate the exhaust flow and convert dynamic energy to a static pressure rise. The diffuser includes a number of struts that contain a support strut encased by a strut airfoil. The struts turn a flow from the multi-stage turbine towards the axial direction when the gas turbine engine is operated within a desired performance range.

With the advancement of material technology, the number of struts in exhaust diffusers may be decreased. Exhaust diffusers that contained 10 struts may now contain fewer. The decreasing number of struts has lead to difficulties.

Exhaust diffusers with 4 to 6 struts often do not have enough solidity to straighten the gas flow. Instead, the 4 to 6 struts amplify the swirl, thereby creating bigger aerodynamic blockage and losses in the high mach number region. A strut cover is needed that guides the swirl, diffuses the flow of gas on the pressure side, reduces aerodynamic blockage, improves overall performance, or avoids strut wake creation.

### BRIEF SUMMARY OF THE INVENTION

In one aspect, this disclosure relates to a strut airfoil for use in an exhaust diffuser. In one embodiment, the strut airfoil has a curved leading edge, a curved tail edge with a smaller radius than the leading edge, and two surfaces that connect the leading edge and the tail edge. When the strut airfoil of this embodiment is viewed in cross-section, the leading edge and tail edge are offset so that one of the surfaces connecting the leading edge with the tail edge is substantially linear for more than 50% of the distance from the leading edge to the tail edge, and the second surface is tapered over a portion of the distance from the leading edge to the tail edge.

In another aspect, this disclosure relates to a gas turbine. In one embodiment, the gas turbine has moving blades attached to a rotor, an exhaust differ comprising a strut, and a strut airfoil. In this embodiment, the exhaust diffuser takes up combustion gas from the moving blades; the strut supports the rotor, and the strut airfoil is arranged around the strut. In this embodiment, the strut airfoil comprises any of the structures or designs described herein.

### BRIEF DESCRIPTION OF THE FIGURES

FIG. 1a is a cross-sectional depiction of an asymmetric airfoil as described herein.

FIG. 1b is a cross-sectional depiction of an airfoil from the prior art.

FIG. 2 is a cross-sectional depiction of an asymmetric airfoil as described herein.

FIG. 3 is a depiction of a gas turbine engine.

FIG. 4 is a depiction of an exhaust diffuser containing 4 struts.

FIG. 5 depicts the pressure drop of a symmetric strut airfoil.

FIG. 6 depicts the pressure drop of an asymmetric strut airfoil as described herein.

FIG. 7 depicts the pressure drops caused by the prior art strut airfoils and one embodiment of the strut airfoils described herein.

FIG. 8 depicts the performance of the prior art strut airfoils and one embodiment of the strut airfoils described herein.

FIG. 9 is a side-view depiction of a strut airfoil as described herein.

FIG. 10 depicts the flow diffusion on the prior art strut airfoil at 40 inches.

FIG. 11 depicts the flow diffusion on one embodiment of the strut airfoil described herein at 40 inches.

### DETAILED DESCRIPTION OF THE INVENTION

In one embodiment, the strut airfoil has a curved leading edge, a curved tail edge with a smaller radius than the leading edge, and two surfaces that connect the leading edge and the tail edge. When the strut airfoil of this embodiment is viewed in cross-section, the leading edge and tail edge are offset so that one of the surfaces connecting the leading edge with the tail edge is substantially linear for more than 50% of the distance from the leading edge to the tail edge, and the second surface is tapered over a portion of the distance from the leading edge to the tail edge.

### Curved Edges

Generally, the curved leading edges of the strut airfoils described herein are of a different size than the curved tail edges. Typically, the curved leading edge has a larger radius than the curved tail edge.

Although the term “radius” is used throughout this specification to differentiate the sizes of the curved leading edges and the curved tail edges, the term “radius” does not imply that all of the curves in the leading and tail edges are circular.

While they may be circular in certain embodiments, the curves of the leading edges and tail edges may also be non-circular. For example, the curves may be elliptical, parabolic, asymmetric, etc. If the curves of the leading edge and tail edge are non-circular, either the major or minor radii should be used consistently to compare the sizes of the leading edges and tail edges.

In certain embodiments, the curved leading edge and curved tail edge, when viewed in cross-section, are offset. Typically, the leading edge and tail edge are offset so that when a chord is drawn that bisects each curved edge, the surface areas of the cross-section on either side of the chord are unequal.

### Connecting Surfaces

In certain embodiments, one of the surfaces connecting the leading edge and the tail edge may be substantially linear for more than 50% of the distance from the leading edge to the tail edge. In certain embodiments, one of the surfaces connecting the leading edge and the tail edge may be substantially linear for more than 55% of the distance from the leading edge to the tail edge. In certain embodiments, one of the surfaces connecting the leading edge and the tail edge may be substantially linear for more than 65% of the distance from the leading edge to the tail edge. In certain embodiments, one of the surfaces connecting the leading edge and the tail edge may be substantially linear for more than 75% of the distance from the leading edge to the tail edge. In certain embodiments, one of the surfaces connecting the leading edge and the tail edge may be substantially linear for more than 85% of the distance from the leading edge to the tail edge. In certain embodiments, one of the surfaces connecting the leading edge and the tail edge may be substantially linear for more than 95% of the distance from the leading edge to the tail edge.

In certain embodiments, the distance from the leading edge to the tail edge may be measured from where the surface connects to the leading edge to where it connects to the tail edge. In other embodiments, the distance may represent the chord of the strut airfoil. Typically, the chord is a longitudinal line that bisects each curved edge.

In one embodiment, the surfaces connecting the leading edge to the tail edge are substantially parallel proximal to the leading edge. In one particular embodiment, the second surface is parallel to the first surface for at least 30% of the distance from the leading edge to the tail edge. In another particular embodiment, the second surface is parallel to the first surface for at least 40% of the distance from the leading edge to the tail edge. In yet another particular embodiment, the second surface is parallel to the first surface for at least 50% of the distance from the leading edge to the tail edge.

In one embodiment, the second surface is tapered over a portion of the distance from the leading edge to the tail edge.

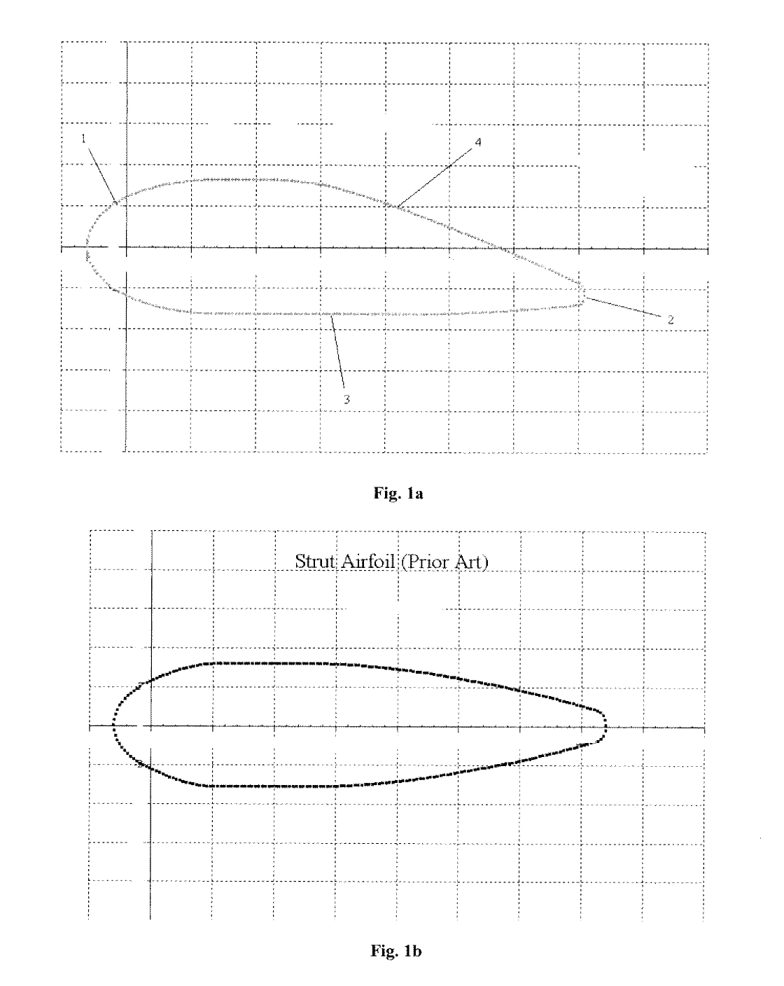

One embodiment of the strut airfoil described herein is illustrated in cross-section in FIG. 1a. Also included in FIG. 1b, for comparison, is the depiction of a cross-section of a strut airfoil from the prior art. Whereas the strut airfoil from the prior art is symmetric, the strut airfoils described herein are generally asymmetric.

In the embodiment depicted in FIG. 1a, the strut airfoil, when viewed in cross-section, has a curved leading edge 1, a curved tail edge 2, and two surfaces that connect the leading edge and the tail edge. One of these surfaces, first surface 3 is substantially linear for more than 50% of the distance from the leading edge to the tail edge. The other, second surface 4 is tapered over a portion of the distance from the leading edge 1 to the tail edge 2.

Also in the embodiment depicted in FIG. 1a, the curved leading edge 1 and the curved tail edge 2 are of different size. In this embodiment, the curved leading edge 1 has a larger radius than the curved tail edge 2.

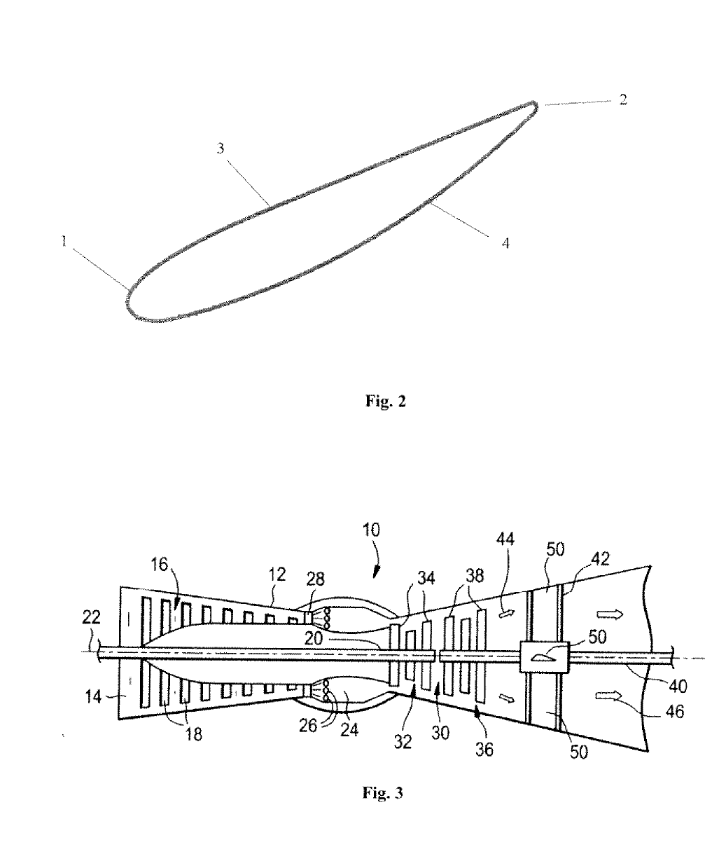

Another embodiment of the strut airfoil described herein is depicted in FIG. 2. FIG. 2 illustrates a cross-sectional view of the strut airfoil. In this embodiment, the strut airfoil has a curved leading edge 1 that has a larger radius than the curved tail edge 2. The leading edge 1 and tail edge 2 are connected by a first surface 3 that is substantially linear for more than 50% of the distance between the leading edge and tail edge; and a second surface 4 that is tapered over a portion of the distance from the leading edge to the tail edge.

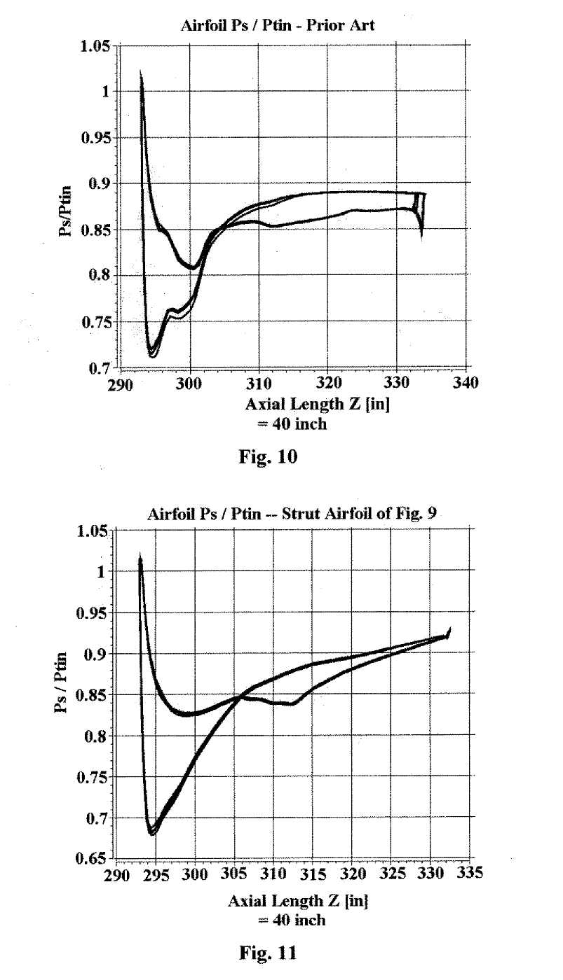

Yet another embodiment of the strut airfoil described herein is depicted in FIG. 9. FIG. 9 is a side-view of the strut airfoil, and shows one of the surfaces 1 connecting the leading edge 2 with the tail edge 3.

### Gas Turbine

Referring to FIG. 3, a heavy-duty gas turbine engine is shown generally at 10. The gas turbine engine 10 has a generally annular shape defined by an outer turbine casing 12. An inlet 14 is defined at one end of the gas turbine engine 10. The inlet 14 leads to a compressor 16 that is defined by and a number of compressor blades 18 disposed within the casing 12. The compressor blades 18 are disposed on a shaft 20 that extends along a centerline 22 of the casing 12, with the compressor blades 18 and shaft 20 configured to define a decreasing volume. Airflow ingested into the gas turbine engine 10 at the inlet 14 is compressed as it passes through the compressor 16. A number of combustors 24 are disposed downstream of the compressor 16, and are positioned axially about the shaft 20. The combustors 24 have a premixing chamber and a combustion chamber (both of which are not shown). The airflow from the compressor 16 is ingested through entry ports 26 into the premixing chamber. Also, fuel from a fuel inlet 28 is delivered into the premixing chamber.

This air and fuel are mixed within the premixing chamber to form a fuel and air mixture that flows into the combustion chamber where it is ignited, as is known. A multi-stage turbine 30 is disposed within the casing 12 downstream of the combustors 24. First stages 32 of the multi-stage turbine 30 are defined by a plurality of turbine vanes 34 disposed on the shaft 20. Final stages 36 of the multi-stage turbine 30 are defined by a plurality of turbine vanes 38 disposed on an output drive shaft 40. The output drive shaft 40 also extends along the centerline 22 of the casing 12, as it is axially aligned with the shaft 20, but rotates independently thereof. The heated compressed air flow from the combustors 24 turns the multi-stage turbine 30.

The rotation of the first stages 32 of the multi-stage turbine 30 rotates the shaft 20, which in turn drives the compressor 16. The rotation of the final stages 36 of the multi-stage turbine 30 rotates the output drive shaft 40, which in turn drives a generator (not shown). A diffuser 42 is disposed aft of the final stages 36 of the multi-stage turbine 30 and is configured to decelerate the exhaust flow and convert dynamic energy to a static pressure rise. The diffuser 42 includes a number of turning struts 50 that contain a support strut encased by an aerodynamic faring. The struts 50 turn a flow 44 from the multi-stage turbine 30 towards the axial direction, resulting in a flow 46, when the gas turbine engine 10 is operated within a designed performance range. The struts 50 are disposed circumferentially within the annulus of the diffuser 42.

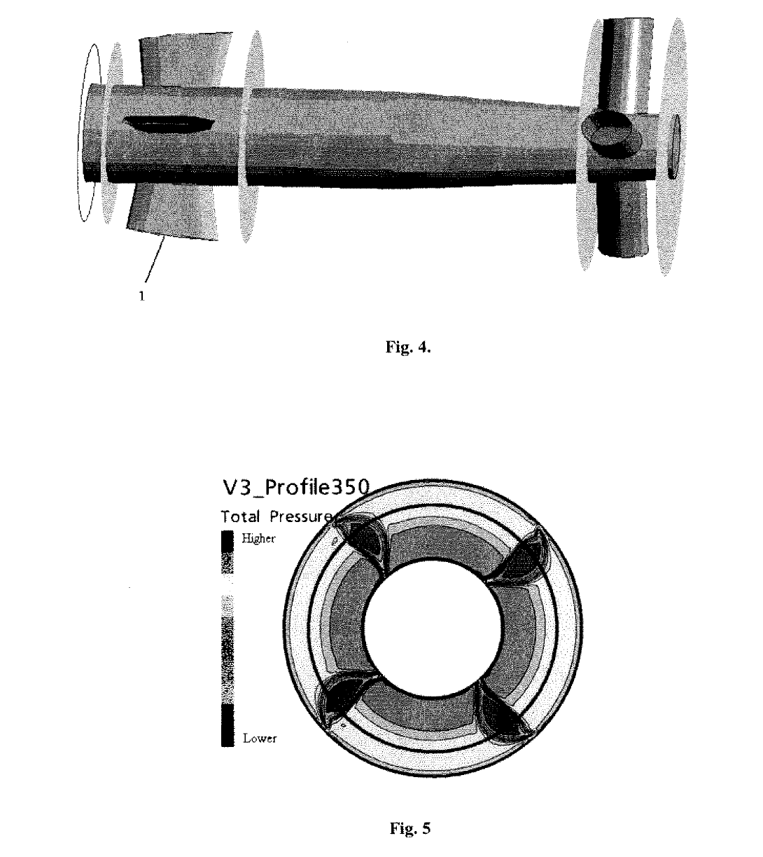

The number of struts in the exhaust diffusers described herein may be 10 or fewer. In certain embodiments, the exhaust diffuser contains 8 or fewer struts. In certain embodiments, the exhaust diffuser contains 6 or fewer struts. In one embodiment, the exhaust diffuser contains 4 struts. A 4-strut setup is illustrated in FIG. 4, which depicts four struts 1.

The struts and strut airfoils described herein may be fabricated from any acceptable materials, including those known in the prior art. In certain embodiments, the quality or strength of the materials used to fabricate the struts or strut airfoils may reduce the number of struts needed in the gas turbines disclosed herein.

### Performance of the Strut Airfoils

The strut airfoils described herein offer several advantages over the strut airfoils disclosed in the prior art. The prior art strut airfoils, such as the symmetric airfoil depicted in FIG. 1b, perform especially poorly in exhaust diffusers with 4 to 6 struts, because the struts do not have enough solidity to straighten the air flow. Instead, the prior art strut airfoils amplify the swirl, thereby creating bigger aerodynamic blockage and losses in the high mach number region.

Even in exhaust diffusers with fewer than 10 struts, including those with 4 to 6 struts, the strut airfoils described herein guide the swirl and diffuse the flow on the pressure side. Thus, the strut airfoils reduce aerodynamic blockage, improve performance, and avoid strut wake creation.

### Example 1

### Pressure Loss Induced by Strut Airfoil

FIG. 5 illustrates the performance of the prior art strut airfoil from FIG. 1b in an exhaust diffuser containing 4 struts. This figure depicts the changes in velocity and pressure caused by the prior art strut airfoils. FIG. 5 offers a cross-sectional view of the pressure drop in the exhaust diffuser that is caused by the prior art strut airfoil. The figure depicts four, large low pressure zones that correspond roughly with the positions of the four struts.

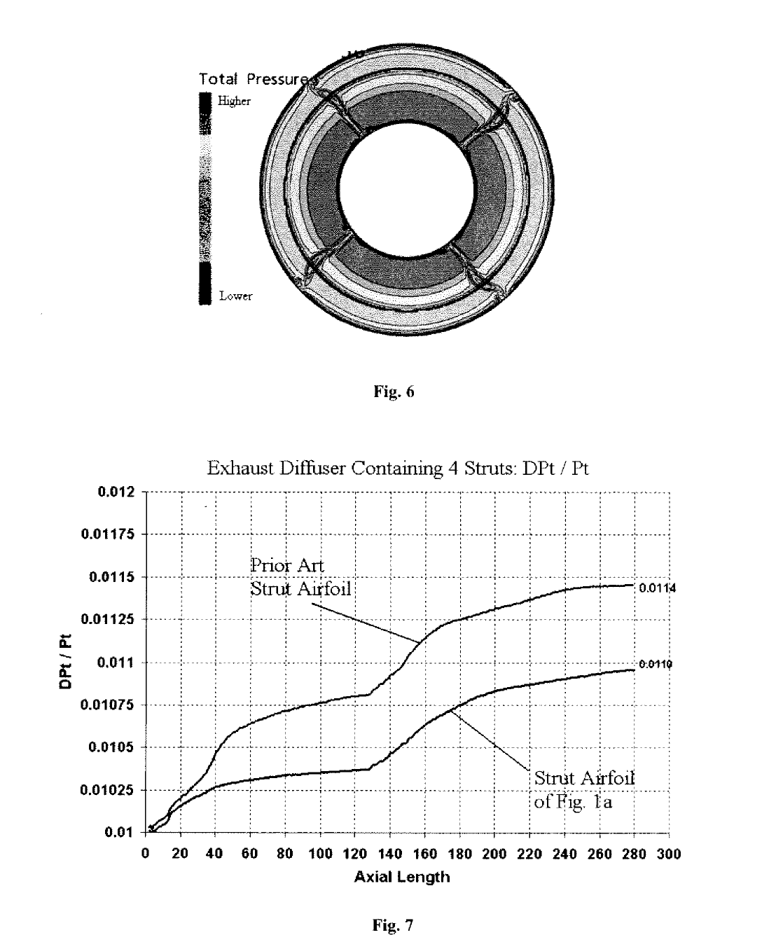

In contrast, FIG. 6 illustrates the performance of an embodiment of the strut airfoil described herein. This figure depicts the changes in velocity and pressure caused by the asymmetric strut airfoil depicted in FIG. 1a. FIG. 6 shows a cross-sectional view of the pressure drop in the exhaust diffuser that is caused by one embodiment of the strut airfoil described herein and depicted in FIG. 1a. The four low pressure zones in FIG. 6 that correspond roughly with the positions of the four strut airfoils are much smaller than those appearing in FIG. 5.

### Example 3

### Pressure Loss Induced by Strut Airfoil

FIG. 7 also illustrates the differences in pressure loss introduced by the prior art strut airfoil and one embodiment of the strut airfoil according to this disclosure, which are depicted in FIGS. 1a and 1b. According to FIG. 7, the pressure drop caused by the strut airfoil of FIG. 1a is generally lower than the pressure drop caused by the prior art strut airfoil, depicted in FIG. 1b.

### Example 4

### Performance of Strut Airfoil

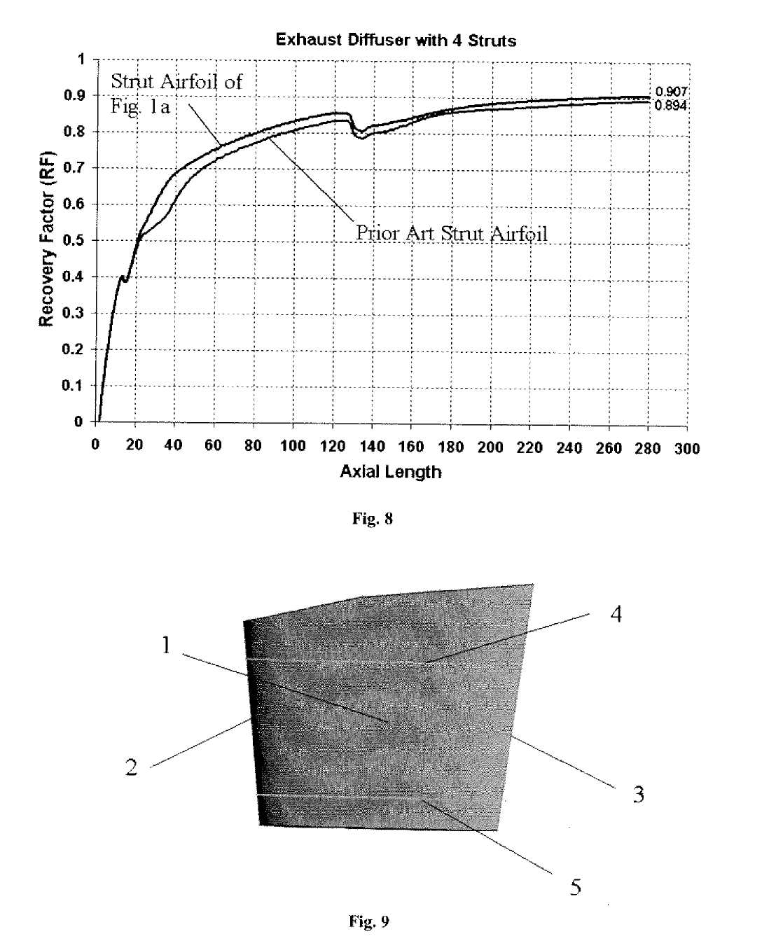

FIG. 8 illustrates the performance of the strut airfoil of FIG. 1a, compared with the prior art strut airfoil, depicted in FIG. 1b. FIG. 8 shows that the performance of the presently-described strut airfoil is superior, especially from approximately 20 to approximately 130. This region of improved performance corresponds with the location of the strut and strut airfoil in the exhaust diffuser.

### Example 5

### Flow Diffusion on Strut Airfoil

FIG. 10 illustrates the flow diffusion on the prior art strut airfoil depicted in FIG. 1b, where the longitudinal length of the strut airfoil is 40. FIG. 11 illustrates the flow diffusion on the strut airfoil described herein, which is also depicted in FIG. 1a and FIG. 9, where the longitudinal length of the strut airfoil is 40 inches. FIG. 9 illustrates the longitudinal lengths of 40 inches 5 and 62 inches 4. Comparing FIG. 10 with FIGS. 11 demonstrates the improved performance of the strut airfoils described herein: the flow diffusion in FIG. 11 is above 0.9 at the same location on the strut airfoil. Due to the improved design of the strut airfoils described herein, there is a higher static pressure in the diffuser.

While the invention has been described in detail in connection with only a limited number of embodiments, it should be readily understood that the invention is not limited to such disclosed embodiments. Rather, the invention can be modified to incorporate any number of variations, alterations, substitutions, or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but it is only limited by the scope of the appended claims.

We claim:

1. A strut airfoil for use in an exhaust diffuser comprising:
a curved leading edge;
a curved tail edge having a smaller radius than the leading edge;
a first surface; and
a second surface, wherein the first surface and second surface connect the leading edge and the tail edge, wherein, when viewed in cross-section, the leading edge and tail edge are offset so that the first surface connecting the leading edge with the tail edge is substantially linear for more than 50% of the distance from the leading edge to the tail edge, and the second surface is tapered over a portion of the distance from the leading edge to the tail edge.

2. The strut airfoil of claim 1, wherein the first surface is substantially linear for more than 55% of the distance from the leading edge to the tail edge.

3. The strut airfoil of claim 1, wherein the first surface is substantially linear for more than 65% of the distance from the leading edge to the tail edge.

4. The strut airfoil of claim 1, wherein the first surface is substantially linear for more than 75% of the distance from the leading edge to the tail edge.

5. The strut airfoil of claim 1, wherein the first surface is substantially linear for more than 85% of the distance from the leading edge to the tail edge.

6. The strut airfoil of claim 1, wherein the first surface is substantially linear for more than 95% of the distance from the leading edge to the tail edge.

8. The strut airfoil of claim 1, wherein the second surface is parallel to a portion of the first surface proximal to the leading edge.

9. The strut airfoil of claim 8, wherein the second surface is parallel to the first surface for at least 50% of the distance from the leading edge to the tail edge.

10. A gas turbine comprising:
a rotor;
an exhaust diffuser;
the exhaust diffuser comprising a strut, wherein the strut supports the rotor; and
a strut airfoil;
the strut airfoil comprising a curved leading edge, a curved tail edge, a first surface, and a second surface,
wherein the curved tail edge comprises a smaller radius than the curved leading edge, and wherein the first surface and the second surface connect the curved leading edge and the curved tail edge,
wherein, when viewed in cross-section, the leading edge and tail edge are offset so that the first surface is substantially linear for more than 50% of the distance from the leading edge to the tail edge, and the second surface is tapered over a portion of the distance from the leading edge to the tail edge, and
wherein the strut airfoil is arranged around the strut.

11. The gas turbine of claim 10, wherein the exhaust diffuser comprises 10 or fewer struts.

12. The gas turbine of claim 10, wherein the exhaust diffuser comprises 8 or fewer struts.

13. The gas turbine of claim 10, wherein the exhaust diffuser comprises 6 or fewer struts.

14. The gas turbine of claim 10, wherein the exhaust diffuser comprises 4 struts.

15. The strut airfoil of claim 10, wherein the second surface is parallel to a portion of the first surface proximal to the leading edge.

16. The strut airfoil of claim 10, wherein the second surface is parallel to the first surface for at least 50% of the distance from the leading edge to the tail edge.
